(19) United States
(12) Patent Application Publication
(10) Pub. No.: US 2015/0086796 A1
(43) Pub. Date: Mar. 26, 2015

(54) CERAMIC THERMALLY INSULATING LAYER SYSTEM HAVING AN EXTERNAL ALUMINUM-RICH LAYER AND METHOD

(71) Applicant: Siemens Aktiengesellschaft, Munich (DE)

(72) Inventors: Maria del Mar Juez Lorenzo, Karlsruhe (DE); Vladislav Kolarik, Karlsruhe (DE); Veronica Kuchenreuther, Karlsruhe (DE); Werner Stamm, Mulheim an der Ruhr (DE)

(73) Assignee: Siemens Aktiengesellschaft, Munich (DE)

(21) Appl. No.: 14/378,676

(22) PCT Filed: Dec. 13, 2012
(86) PCT No.: PCT/EP2012/075343

§ 371 Date: Aug. 14, 2014

(30) Foreign Application Priority Data
Feb. 22, 2012 (EP) 12156510.5

(51) Int. Cl. F01D 5/28; B32B 15/20; B32B 15/04; F01D 9/02; B32B 18/00

(52) U.S. Cl. CPC F01D 5/288; F01D 9/02; B32B 18/00; B32B 15/04; B32B 15/20; F05D 2300/2118; F05D 2300/2112; F05D 2260/231; B32B 2250/03; B32B 2603/00
USPC 428/450; 416/229 R; 415/177; 427/404

(57) ABSTRACT

A layer system is provided that has at least: a substrate, a ceramic layer and an outermost layer, which has an aluminum-rich form, in particular directly on the ceramic layer, and optionally a metallic bonding layer between the substrate and the ceramic layer, and in which the outermost layer has aluminum particles, in particular aluminum particles with a particle size of 100 nm to 50 μm. As a result of applying particles of aluminum to an outermost layer, the ceramic layer is better protected against what is known as CMAS (calcium, magnesium, aluminum and silicon) attacks.

### CROSS REFERENCE TO RELATED APPLICATIONS

This application is the US National Stage of International Application No. PCT/EP2012/075343 filed Dec. 13, 2012, and claims the benefit thereof. The International Application claims the benefit of European Application No. EP12156510 filed Feb. 22, 2012. All of the applications are incorporated by reference herein in their entirety.

### FIELD OF INVENTION

The invention relates to a layer system having a ceramic layer to which an aluminum-rich outer layer is applied, and to a process.

### BACKGROUND OF INVENTION

When carrying out inspections on gas turbines, attacks on thermal barrier layers are observed, particularly in the case of oil-fired turbines. Closer examinations show that—as has also already been observed in aviation turbines—CMAS attacks were the trigger for the damage to the layer. A compound of calcium, magnesium, aluminum and silicon or iron leads to low-melting eutectics on thermal barrier layers in the temperature range around 1200° C.-1250° C. or higher. These compounds release the yttrium oxide needed for stabilization from the thermal barrier layer. This leads to strongly monoclinic phase transitions upon a change in temperature in the ceramic, and these lead to the destruction of the thermal barrier layer.

To date, this effect has arisen only to a limited extent in stationary turbines, since the surface temperatures of the thermal barrier layer used did not reach the required melting temperatures of CMAS and iron. Protection was therefore not needed. With an increasing gas temperature, however, this attack increases in magnitude.

### SUMMARY OF INVENTION

It is therefore an object of the invention to solve the aforementioned problem.

The object is achieved by a layer system and a process as claimed.

The dependent claims list further advantageous measures which can be combined with one another, as desired, in order to achieve further advantages.

Within the context of investigations with extremely small particles of aluminum, it was possible to show that particles of this type form high-melting compounds in connection with CMAS, for example anorthite. These particles, in the order of magnitude of 100 nm to 50 μm, can be introduced into a binder matrix and readily sprayed using an air gun. This matrix is applied to a thermal barrier layer surface. By virtue of these extremely small particles, on the one hand a large active surface area is available, but on the other hand the system is very ductile owing to the loose compound structure. The chemically very aggressive CMAS compound reacts with the aluminum excess to form anorthite. This is a high-melting compound which prevents or at least reduces the CMAS attack. A particular advantage of this coating is the possibility of repeated application even when the component is installed. The anorthite layer which builds up additionally affords protection against the attack of the CMAS compound.

The aluminum-containing protective layer can also be applied to rotor blades and guide vanes of a gas turbine when the latter are installed, in which case in particular a housing half of the gas turbine is open.

The coating can be applied cost-effectively (aluminum particles in a binder matrix) and easily.

The additional protective layer system makes it possible for the operator of a gas turbine to also operate a cost-effective partially stabilized zirconium oxide system under a CMAS attack.

### BRIEF DESCRIPTION OF THE DRAWINGS

In the drawing:

FIG. 1 shows a layer system according to the invention,

FIG. 2 shows a turbine blade or vane, and

FIG. 3 shows a list of superalloys.

### DETAILED DESCRIPTION OF INVENTION

The description and the figures represent merely exemplary embodiments of the invention.

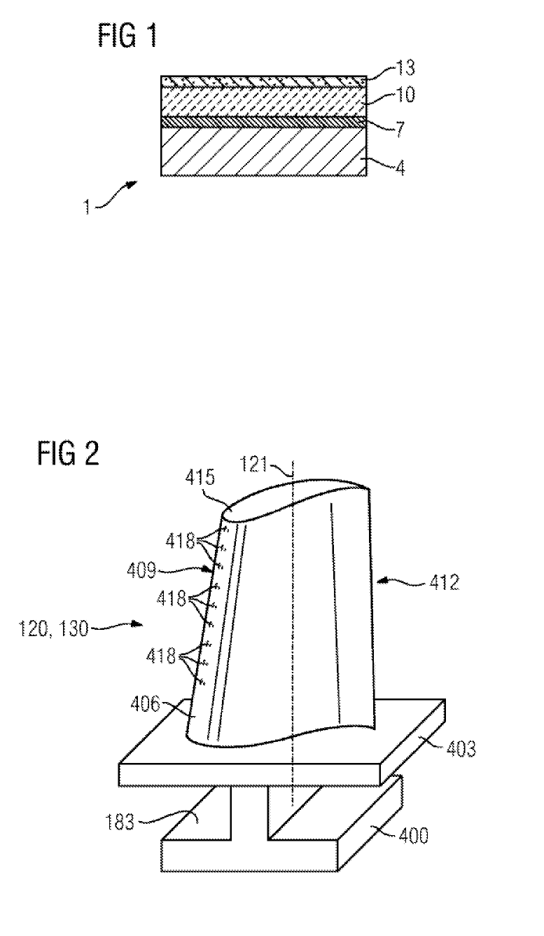

FIG. 1 shows a layer system 1 according to aspects of the invention.

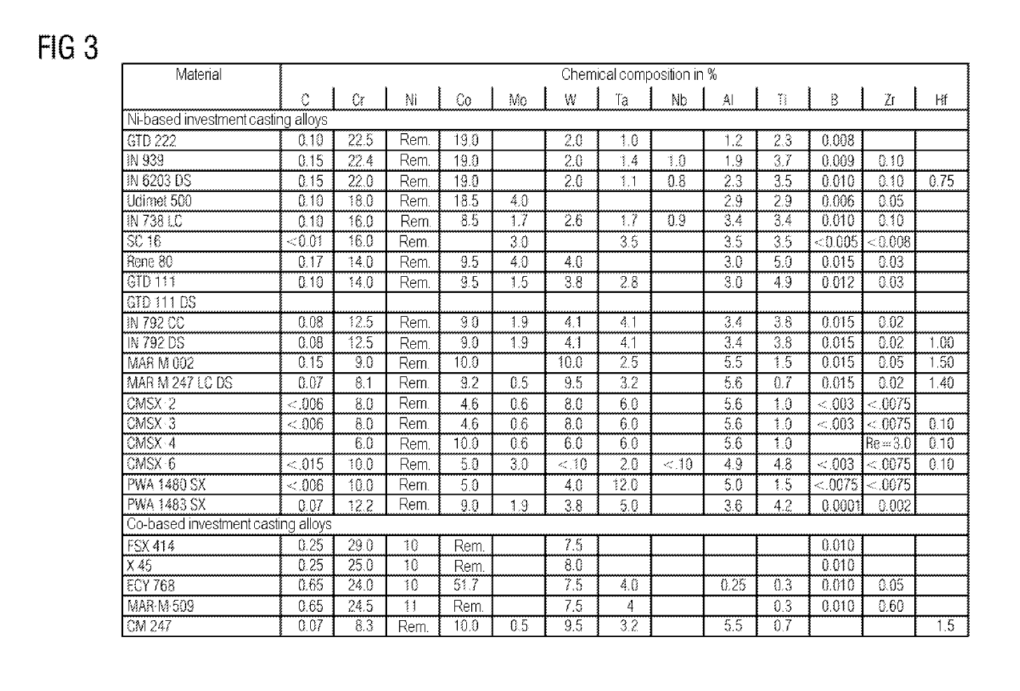

The layer system 1 comprises a substrate 4. The substrate 4 comprises, in particular consists of, a nickel-based or cobalt-based superalloy, in particular as shown in FIG. 3.

The layer system 1 furthermore comprises a ceramic layer 10. The ceramic layer 10 can comprise zirconium oxide, partially stabilized zirconium oxide or two-layered ceramic systems made up of zirconium oxide and/or a pyrochlore phase such as gadolinium hafnate or zirconate.

A metallic bonding layer and/or an aluminum oxide layer (TGO) can be present between the ceramic layer 10 and the substrate 4. These can be aluminide layers or NiCoCrAlY layers which form the TGO.

Further ceramic thermal barrier layer systems as are known in the case of high-temperature components, in particular in the case of turbine blades or vanes or components of gas turbines, can be the starting basis.

A layer of aluminum particles is present as the outermost layer 13 on the ceramic layer 10, said layer 13 being exposed to a hot gas in a gas turbine in the case of a turbine blade or vane.

It is preferable for the layer to consist of aluminum or aluminum particles.

The particle size here is preferably 0.1 μm to 50 μm.

Aluminum always has an oxide layer.

In particular, the proportion of aluminum (Al) represents the largest proportion.

It is also possible to use layers 13 containing compounds which comprise aluminum in a superstoichiometric ratio or comprise aluminum in excess, but preferably no aluminides (NiAl, . . . ) or MCrAlY.

Possible processes for applying the layer 13 made of an emulsion consisting of the Al particles and a binder are spraying, application using a brush, application using a roller or dipping the components into the emulsion.

Further types of aluminum coating are possible, such as aluminum plating.

FIG. 2 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10A1-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier layer, which is preferably the outermost layer, to be present on the MCrAlX, consisting for example of ZrO₂, Y₂O₃-ZrO₂, i.e. unstabilized, partially stabilized or fully stabilized by yttrium oxide and/or calcium oxide and/or magnesium oxide.

The thermal barrier layer covers the entire MCrAlX layer.

Columnar grains are produced in the thermal barrier layer by suitable coating processes, such as for example electron beam physical vapor deposition (EB-PVD).

Other coating processes are possible, e.g. atmospheric plasma spraying (APS), LPPS, VPS or CVD. The thermal barrier layer may include grains that are porous or have micro-cracks or macro-cracks, in order to improve the resistance to thermal shocks.

The thermal barrier layer is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

1-9. (canceled)

10. A layer system, comprising:
a substrate,
a ceramic layer and
an outermost layer,
wherein the outermost layer has an aluminum-rich form, and
wherein the outermost layer comprises aluminum particles.

11. The layer system as claimed in claim 10,
wherein the ceramic layer comprises zirconium oxide.

12. The layer system as claimed claim 10,
wherein the outermost layer consists of aluminum (Al).

13. The layer system as claimed in claim 10,
wherein the layer system is in the form of a turbine component.

14. A process for producing a layer system, comprising:
producing a layer system comprising a substrate, a ceramic layer and an outermost layer, as claimed in claim 10, and
applying aluminum particles directly to the ceramic layer by means of a binder.

15. The process as claimed in claim 14,
wherein the aluminum-containing layer is applied in the installed state of a component, which represents the layer system.

16. The process as claimed in claim 14,
wherein a particle size for the aluminum particles is 100 nm to 50 μm.

17. The process as claimed in claim 14,
wherein an emulsion made up of aluminum particles and the binder is applied by spraying, brushing, rolling on or dipping.

18. The layer system as claimed in claim 10, wherein the aluminum-rich form is directly on the ceramic layer.

19. The layer system as claimed in claim 10, wherein a metallic bonding layer is between the substrate and the ceramic layer.

20. The layer system as claimed in claim 10, wherein the aluminum particles have a particle size of 100 nm to 50 μm.

21. The layer system as claimed in claim 11, wherein the ceramic layer is stabilized with yttrium oxide.

22. The layer system as claimed in claim 13, wherein the layer system is in the form of a turbine blade or vane.
